(19) United States
(12) Patent Application Publication
(10) Pub. No.: US 2026/0300458 A1
(43) Pub. Date: Oct. 1, 2026

(54) METHOD FOR CREATING A TOKENIZED PERSONAL IDENTIFICATION, A COMPUTER PROGRAM, AND A DATA PROCESSING SYSTEM

(71) Applicant: CIBEX AG, Ruggell (LI)

(72) Inventor: Geoffrey CARR-HARRIS, Toronto, Ontario (CA)

(21) Appl. No.: 19/115,736

(22) PCT Filed: Oct. 3, 2022
(86) PCT No.: PCT/IB2022/059407

§ 371 Date: Mar. 26, 2025

(51) Int. Cl. G06F 21/33; G06F 21/57; G06F 21/64; G06Q 20/36; G06Q 20/40; H04L 9/00; H04L 9/32

(52) U.S. Cl. CPC G06F 21/33; G06F 21/577; G06F 21/645; G06Q 20/36; G06Q 20/401; H04L 9/3213; H04L 9/50; G06Q 2220/00

(57) ABSTRACT

A method for creating a tokenized personal identification of a person or an organization in a decentralized computer network. The method includes at least the following steps: providing a connection of a first computing device in a computer network, receiving at least two verification requests regarding the person or organization via the first computing device in the computing network, providing of at least one risk management verification data, at least based on information delivered in the at least two verification requests in the computer network, creating at least one tokenized personal identification data in a decentralized computer network, while the tokenized personal identifications data consider at least the risk management verification data.

The present invention relates to a method for creating a tokenized personal identification according to claim 1, a computer program according to claim 13, and a data processing system according to claim 14.

### TECHNICAL FIELD OF THE INVENTION

Various embodiments of the present invention concern creation of a tokenized personal identification of a person or an organization in a decentralized computer network, using a computer program and/or a data processing system.

### BACKGROUND OF THE INVENTION

EP 3 477 891 A1 disclosing a method for recording a digital identity of a first user, performed by a computing device of a first verification entity identified by a first verification entity identifier: receiving from the first user at least one first user identity document and extracting user personal identifiable information data elements from said user identity document, after verification, encrypting using a public key of the first verification entity and recording said encrypted user personal identifiable information data elements in a first distributed ledger whose access is authorized to a first set of computing devices only, generating a user identifier to be sent to said user and recording a hash of said user identifier in a second distributed ledger and, for each verified user personal identifiable information data element, an attestation including the first verification entity identifier and a hash of said user personal identifiable information data element, and recording each generated attestation in said second distributed ledger, for each generated attestation, recording in said second distributed ledger a relationship between the generated user identifier and said generated attestation, wherein said first and second distributed ledgers are configured such that access to the first distributed ledger is more restricted than access to the second distributed ledger.

The disadvantage of this system is that the user personal identification data is stored in said first distributed ledger outside the user's personal devices and, thus, potentially accessible to non-authorized persons.

WO 2020/008367 A1 discloses a method for creating a digital ID or digital data storage of a person or an organization using at least one identity document from said person or organization. Said identity document is stored in an encrypted personal data container. Said method calculates a hash code, which is stored in a decentralized network associated with a user ID.

The disadvantage of this method is that the user's trustworthiness is insufficiently checked, and the user's creditworthiness is not checked at all. Thus, said method is insufficient for use in the cryptocurrency world.

The need to checks of the identity as well as assets of a person in each case of establishing contracts and the beginning of interaction between a person or organization and an organization having a need to determine with whom the organization is dealing specifically is a serious drawback. There is a general need for advancements in this field of technology.

### SUMMARY OF THE INVENTION

An object of the present invention is to overcome the disadvantages of the prior art. It is further an object of the present invention to create a tokenized personal identification of a person or an organization in an improved way, so that the contributing parties may work together in a highly trustful manner, especially in the cryptocurrency environment. In particular, a method, a computer program and a data processing system are to be provided, which have a high acceptance by users with respect to trustiness, applicability, and usability in the cryptocurrency environment.

At least one of these objects has been solved by the features of the independent patent claims. Other preferred embodiments are indicated in the dependent claims.

In particular, according to a first aspect of the present disclosure, the object is achieved by a method for creating a tokenized personal identification of a person or an organization in a decentralized computer network. Said method comprises at least the following steps:
a) Providing a connection of a first computing device in a computer network;
b) Receiving at least two verification requests regarding the person or organization via said first computing device in the computing network;
c) Providing of at least one risk management verification data, at least based on information delivered in the at least two verification requests in the computer network;
d) Creating at least one tokenized personal identification data in a decentralized computer network, while said tokenized personal identifications data consider at least the risk management verification data.

Said method offers a user of the first computing device an easy solution to provide the ownership and the origin of the assets. Said method makes cryptocurrency owners feel safe by making transactions, trading, buying, or withdrawing cryptocurrency. A third party may prove that information from the user afterwards, when participating in the cryptocurrency environment. The solution will work like a decentralized application (DApp) by verifying the user. After the verification process, said method will create a “Cryptographic Passport” (CryptoPass) in a decentralized way—generating a cryptographic token that provides cryptographically proven identification data, providing that a user is a legit person with legal assets, who successfully may go through the verification process. Said method provides a tokenized personal identification of a person or an organization with increased secure and reliable properties, such that contributing parties (e.g. a cryptocurrency exchange provider, financial institution, government entities, or others) may work together in a highly trustful manner in many different businesses. In the future, users are required to prove their identity gapless before getting access to data or benefit from services of third parties, which may be a complicated procedure to get finally such a proof. Said risk management verification data creates high convenience between the user and organizations, institutions, and government, because it is tamperproof, which increases the trustfulness of said tokenized personal identification. After step d) said tokenized personal identification may be hosted as a cryptographic token on a public blockchain platform, thus said method creates a transparent and reliable possibility to work with third parties.

In another embodiment, said at least two verification requests comprise a KYC verification request. Said KYC (know your customer) is a first preferred verification possibility in the method, which comprise fundamental information of the user of the first computing device in the computer network. Said KYC verification requires personal data of the user of the first computing device. Said required personal data may comprise passport data or other official personal documents, like biometry data or certificate of birth or comparable authorized documents. Said KYC secures said tokenized personal identification data with respect to a user confusion. Said user can be registered just once for a tokenized personal identification data. Said KYC verification data will be aggregated, and a proof of identity is easily provided. If said user passes said KYC verification, said KYC verification data is saved in said decentralized network, for example in one or many server computers of the decentralized network. Preferably, said KYC verification data is saved in a blockchain in the decentralized network, which increases the confidentiality of the method.

Alternatively or supplementary, said at least two verification requests comprise an AML verification request. Said AML (anti-money laundering) is a further preferred verification possibility in the above-mentioned method, which helps to detect and report suspicious activity including the predicate offences to money laundering and terrorist financing, such as securities fraud and market manipulation. An AML provider or said user of the first computing device provides sufficient information of the legal origin of the verification data. Third parties, like cryptocurrency exchanges and other financial institutions, can be sure, that the information is compliant with AML regulation and the user's assets are of safe origin. Said AML may also comprise KYT (know your transaction) data, which is a process employed by financial institutions to monitor the merchants' businesses through the analysis of transaction data. Examining transaction data allows accurate and data-driven conclusions to be made, as it produces the essential evidence required upon suspicions over any fraudulent merchant activity. Said AML provider or said user of the first computing device must provide sufficient data to pass the AML verification request. Said AML verification data will be aggregated, and a proof of funds is easily provided. If said users passes said ALM verification, said ALM verification data is saved in said decentralized network, for example in one or many servers of the decentralized network. Preferably, said ALM verification data is saved in a blockchain in the decentralized network, which further increases the confidentiality of the method.

In another embodiment, said at least one risk management verification data comprises at least one information data based on the KYC or AML verification data. Said KYC information data may involve at least one of name, surname, age, gender, jurisdiction, document type, biometry result, politically exposed person (PEP), KYC provider score, country of registration. Said AML information data may involve at least one of AML provider risk score, cryptocurrency wallet age, volumes, and sizes of transactions, cryptocurrency origin, cryptocurrency wallet balance. Therefore, said risk management verification data is connected to the KYC and/or AML verification data. Thus, said risk management verification data comprises very sensitive data of the user of the first computing device and said sensitive data is saved in a blockchain in the decentralized network, which increases the confidentiality of the method.

In another embodiment, before step b) at least one cryptocurrency wallet is connected to said computer network. Said cryptocurrency wallet is owned by the user of the first computing device or said user has permission for using the cryptocurrency wallet. Said cryptocurrency wallet is used on the one hand to pay for services and on the other hand for verifying the ownership of the cryptocurrency wallet and/or check further AML verification data. Furthermore, providing the legal origin of the cryptocurrency in the cryptocurrency wallet supports the compliance for meeting said ALM or KYT verifications.

In another embodiment, an ownership verification data process of the at least one cryptocurrency wallet is performed. This offers an easy solution for cryptocurrency owners to prove the ownership and origin of their cryptocurrency assets. The solution will work like said decentralized application by verifying the user and his cryptocurrency or crypto asset holdings. After the ownership verification process said cryptographic token that provides cryptographically proven identification data, is generated, which ensure that said user is a legit person with legal assets who successfully may go through the verification process. Said ownership verification data process may comprise a verification of the cryptocurrency wallet, using an ETH (Ethereum)-wallet check, which ensure that the cryptocurrency wallet is an ETH-based wallet. Said wallet check may use a typical ETH-based connection process and/or a known Satoshi test, while passing said check, said cryptocurrency wallet is connected to the decentralized network, for finalization the proof of wallet ownership. Third parties, like government entities, are supported to collect taxes and to stop criminals from disguising illegally obtained funds as legitimate income.

Ethereum is a decentralized, open source blockchain with smart contract functionality. Ethereum allows anyone to deploy permanent and immutable decentralized applications onto it, with which users can interact. Decentralized finance (DeFi) applications provide a broad array of financial services without the need for typical financial intermediaries like brokerages, exchanges, or banks, such as allowing cryptocurrency users to borrow against their holdings or lend them out for interest. Ethereum also allows users to create and exchange NFTs (non-fungible tokens), which are unique tokens representing ownership of an associated asset or privilege, as recognized by any number of institutions. Additionally, many other cryptocurrencies utilize the ERC-20 token standard on top of the Ethereum blockchain and have utilized the platform for initial coin offerings. Ethereum transitioned its consensus mechanism from proof-of-work (PoW) to proof-of-stake (PoS). Consequently, Ethereum's energy consumption rate was reduced by about 99.95%. In Ethereum, all smart contracts are stored publicly on every node of the blockchain. Every new transaction is recorded on a new block, which is connected to previous and future blocks in a chain. Fraudsters who want to tamper with one transaction/block would have to tamper all preceding and following blocks, which is possible, but extremely difficult. Alternatively, similar blockchain technologies may be used for creating at least one tokenized personal identification data.

Preferably, said at least one risk management verification data is further based on information data delivered by the ownership verification in the computer network. Said information data may involve at least one of cryptocurrency type, cryptocurrency wallet balance, a verification method, cryptocurrency wallet type. Therefore, said risk management verification data is connected to the connected cryptocurrency wallet and/or said ownership verification data. Thus, said risk management verification data comprises very sensitive data of the cryptocurrency wallet of the user of the first computing device. Said sensitive data is saved in a blockchain in the decentralized network, which increases the confidentiality of the above-mentioned method.

A single user may own several cryptocurrency wallets, but just one tokenized personal identification data, which may comprise the ownership verification data of the different cryptocurrency wallets. Said tokenized personal identification data acts like a single gatekeeper to the decentralized network. Said cannot be transferred from one user to another. It should indicate that the user has valid cryptocurrency, and it wouldn't be unexpectedly frozen by a third party.

In the successful verification process result, said at least one tokenized personal identification data aggregates information from at least two of a KYC service, AML services and ownership of the cryptocurrency wallet service in one single cryptographic token, which is not transferable, and editable. This tokenized personal identification data may be hosted on a public ETH-based blockchain platform as said cryptographic token. Thus, said method provides a tokenized personal identification of a person or an organization with highly increased secure and reliable properties in a single token, such that contributing parties may work together in a highly trustful manner in many different areas, like bank or public authorities.

In another embodiment, said risk management verification data comprises at least one risk score. The more information data from KYC, AML and/or ownership verification is provided during above-mentioned verification processes, the more acceptable said risk management verification data will be and the better the risk score will be. Thus, if said user provides said information data in a trustful way, said risk score will be low. On the other hand, said risk score is high, if said information data e.g. in said ownership verification process, comprises leakages. A user with an excellent low risk score may use this as a certificate of good standing for the business, the finance reputation as well as legal concerns. Said at least one score is computed in a second computer device in the computer network. Said second computer device is part of said decentralized network and thus is independent of the first computer device. Said risk score cannot be manipulated by a user or a third party.

Said tokenized personal identification data may comprise a demand of minima number of KYC information data and/or ALM information data and/or ownership information data of the user of the first computer device. Those minima number at least comprises a full name of the user, the date of birth, an identifier of the KYC, an array of the address of the cryptocurrency wallet and the country of registration as well as said at least one risk management verification data. Said array of address of the cryptocurrency wallet may comprise an address's date of creation, an address's turnover, a balance at the address and/or a risk score for a specific address.

Preferably, said risk management verification data may comprise an overall risk score composed of several risk scores and information data of KYC, of ALM or ownership or verification data. Thus, an overall risk score may easily be used as a certificate of good standing for the business, the finance reputation as well as legal concerns.

One of the advantages of said tokenized personal identification of a person or an organization is that it comprises several components to provide an easy, secure, and transparent service for cryptocurrency owners, e.g. to prove the legal origin of the cryptocurrencies users own. Said tokenized personal identification of a person or an organization comprises several components to provide an easy, secure, and transparent service for cryptocurrency exchanges and other financial institutions, e.g. to be compliant with AML regulation and ensure the safe origin of users' cryptocurrency funds. Furthermore, said tokenized personal identification of a person or an organization comprises several components to provide an easy, secure, and transparent service for government entities, e.g. to collect taxes and to stop criminals from disguising illegally obtained funds as legitimate income.

In another embodiment, said at least one risk management verification data comprises at least one level of risk information. Thus, said information data of KYC, ALM or ownership may be categorized in several risk levels, which allows a better subdivision of the at least one risk management verification data. Some information data may be weighted as very important and will be weighted with a high multiplication, to change the at least one risk score. Preferably, said at least one risk management verification data comprises a multi-level of risk information. Thus, the subdivisions of the at least one risk management verification data is possible in multi-level regime, which increases the reliability of the trustworthiness check in the method.

In another embodiment, said decentralized computer network comprise at least one public blockchain. In principle, access to this type of blockchain is open to any participant—in other words, anyone who wants to can participate in the network, execute transactions, help validate blocks, and view the entire history of the blockchain. This creates a high convenience between the user and organizations, institutions and government, because it is tamperproof, which increases the trustfulness of said tokenized personal identification.

Alternatively or supplementary, said decentralized computer network comprise at least one private blockchain. A private or permissioned blockchain is a form of blockchain where only selected participants have access rights. The private blockchain is not publicly viewable but can only be viewed and verified by authorized persons. It is considered more secure due to the highly regulated access and is therefore preferred in companies for managing internal transactions.

In another embodiment, a database is connected to the computer network, comprising preferably historical data. Said historical data may comprise information data from KYC, ALM and/or ownership information of several users or third parties, which may be verified with the information data provided from a user of the first computing device or an institution, organization, or government. Said historical data may be used to verify the at least one risk score and/or the risk management verification data. Historical user data or cryptocurrency wallet data is compared with the provided information data at least during said at least two verification requests in step b). Said provided information data during the at least two verification requests in step b) may be saved as new historical data in said database. Thus, a reliable data package is created for each user of the above-mentioned method. Said database is preferably needed to save information data about users. Said database may consist of tables likes, users: name, surname, e-mail, date of birth, country, KYC provider, risk score, certified documents.

In another embodiment, said at least one tokenized personal identification data is stored in a certified document. Thus, the above-mentioned information, at least comprising the risk management verification data and/or the at least one risk score, is stored in a certified document.

In another embodiment, a third-party institution is verified to the computer network and said at least one tokenized personal identification data. Said third-party institutions may register in the computer network to get access to the at least one tokenized personal identification data and/or the KYC information and/or ownership information.

Alternatively or supplementary, said certified document is delivered to the third-party institution. Thus, the above-mentioned information, at least comprising the risk management verification data and/or the at least one risk score, is stored in a certified document, which can easily be handed over to an institution or government for their usage. Third parties, like government entities, are supported to collect taxes and to stop criminals from disguising illegally obtained funds as legitimate income.

In another embodiment, said risk management verification data is provided using an artificial intelligence (AI) module, connected to the computing network. Said AI-module comprise at least one calculation algorithm like a neuronal network, a support vector machine or a transformer-calculation-unit for handling the above-mentioned information data, at least to provide said risk management verification data and/or to provide said at least one risk score. Said calculation algorithm of the AI is trained by historical information data and verification data of real user's verification requests.

Preferably said risk management verification data is provided based on a formula using the information of at least one information of the person or the organization. The formula allows a reproducible and comparable calculation of the risk management verification data. Said formula may comprise at least some of the KYC information and/or AML information, which are preferably weighted with a multiplicator. The information enters into the calculation with different weightings, so that important information has a greater influence on the risk management verification data.

Alternatively or supplementary said risk management verification data is provided based on a formula using the information of at least one wallet information data. Said wallet information data may comprise cryptocurrency wallet age, volumes, or country of origin, or country of login. The information may enter into the calculation with different weightings, so that important information has a greater influence on the risk management verification data.

Alternatively or supplementary said risk management verification data is provided based on a formula using the information of at least one information of the cryptocurrency. Said at least one information of the cryptocurrency may comprise cryptocurrency origin, cryptocurrency wallet balance, or sizes of transactions. The information may enter into the calculation with different weightings, so that important information has a greater influence on the risk management verification data.

In particular, according to another aspect of the present disclosure, the object is achieved by a computer program, configured to perform a method as herein disclosed. Said computer program will work like a decentralized application (DApp) by verifying the user and provides a tokenized personal identification of a person or an organization with increased secure and reliable properties, such that contributing parties may work together in a highly trustful manner in many different areas, like bank or public authorities. Said above-mentioned method will be a computer-implemented method.

In particular, according to another aspect of the present disclosure, the object is achieved by a data processing system comprising means for carrying out the steps of the method as herein disclosed. Said data processing system offers a user of the first computing device an easy solution to provide the ownership and the origin of their assets. A third party may prove that information afterwards. The solution will work like a decentralized application (DApp) by verifying the user and provides a tokenized personal identification of a person or an organization with increased secure and reliable properties, such that contributing parties may work together in a highly trustful manner in many different areas, like bank or public authorities. Said risk management verification data creates high convenience between the user and organizations, institutions and government, because it is tamperproof, which increases the trustfulness of said tokenized personal identification. Said data processing system may comprise several modules, e.g. user module with registration and authorization functionality, verification module with KYC data handling, wallet ownership validation module, verification module with AML data handling, an external KYC service module, an external AML/KYT service module, payment module, decentralize application module, database module, a bridge between blockchain and database, application program interface (API) module for the third party institutions. At least some of these modules ensure a secure and reliable data processing system.

In another embodiment, several computers are connected to form a decentralized computer network. Said above-mentioned method will be easily performed by various users all over the world. Furthermore, various third-parties, institutions, organizations, or governments may get access to the data processing system and therefore to the tokenized personal identification of a person or an organization. The above-mentioned steps of the method may be performed in different computers in said decentralized network.

In another embodiment, at least one interface for connecting a first computing device to at least one computer is provided. Said at least one interface may be a platform, a mobile application and/or a website. Thus, said user, third-parties, institutions, organizations, or governments may register in the decentralized network. After registration, they will get access to the above-mentioned method for creating a tokenized personal identification of a person or an organization.

In another embodiment, at least one cryptocurrency wallet is connected to said computer. Connecting said cryptocurrency wallet to a computer, e.g. the first computing device, will allow said user to start an ownership verification request, and to provide the relevant a sensitive data. Said cryptocurrency wallet is owned by the user of the first computing device, or said user has permission for using the cryptocurrency wallet. Said cryptocurrency wallet is used on the one hand to pay for services and on the other hand for verifying the ownership of the cryptocurrency wallet. Furthermore, providing the legal origin of the cryptocurrency in the cryptocurrency wallet supports the compliance.

In another embodiment, at least one computer provides AML data. Thus, ALM information data is usable for verification requests from an ALM service provider.

In another embodiment, at least one computer is a backend computer providing at least one AI module. Said AI module will perform said above-mentioned method. Using a backend computer will increase the data security of the data processing system.

In another embodiment, at least a database is connected to the computer network, providing historical data. Thus, a reliable data package is created for each user of the above-mentioned method. Said database is preferably needed to save information data about users. Said database may consist of tables likes, users, name, surname, e-mail, date of birth, country, KYC provider, risk score, certified documents.

In another embodiment, at least one computer of a third-party institution is connected to the computer network. Said third-party may a KYC provider and/or an AML provider or other official data provider. Alternatively, said third-party institutions may use said connection to buy information, like said risk management verification data or tokenized personal identification of a person or an organization.

By means of the following figures, the invention is explained in more detail by means of examples of embodiments. The list of references is part of the disclosure.

Positional indications, such as “above”, “below”, “right” or “left” are in each case related to the corresponding embodiments and are not to be understood as restrictive.

Indications, such as “first”, “second”, or “further” are in each case related to the corresponding device and are not to be understood as restrictive or enumeration.

### BRIEF DESCRIPTION OF THE DRAWINGS

In order to facilitate better understanding of the present invention, reference is made below to the drawings. These show only exemplary embodiments of the subject matter of the invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

In the figures and the associated description, identical or functionally analogous parts are provided with the same reference numerals.

The invention also encompasses individual features shown in the figures, even if they are shown there in connection with other features and/or are not mentioned above. Further, the term “comprising” and derivatives thereof do not exclude other elements or steps. Likewise, the indefinite article “a” or “one” and derivatives thereof do not exclude a plurality. The functions of multiple features recited in the claims may be performed by a single unit. The terms “substantially”, “approximately”, “about” and the like in connection with a characteristic or a value define, in particular, also exactly the characteristic or exactly the value. All reference signs in the claims are not to be understood as limiting the scope of the claims.

FIG. 1 shows a first inventive method for creating a tokenized personal identification of a person or an organization in a decentralized computer network in a schematic flow diagram,

FIG. 2 shows a registration procedure for the method according to FIG. 1 in a schematic flow diagram,

FIG. 3 shows a user authorization procedure for the method according to FIG. 1 in a schematic flow diagram,

FIG. 4 shows a wallet authorization procedure for the method according to FIG. 1 in a schematic flow diagram,

FIG. 5 shows a “know your customer” procedure for the method according to FIG. 1 in a schematic flow diagram,

FIG. 6 shows an “anti-money laundering” procedure for the method according to FIG. 1 in a schematic flow diagram,

FIG. 7 shows a token generation procedure for the method according to FIG. 1 in a schematic flow diagram,

FIG. 8 shows a token emission procedure for the method according to FIG. 1 in a schematic flow diagram,

FIG. 9 shows a certified document creation procedure for the method according to FIG. 1 in a schematic flow diagram,

FIG. 10 shows a third-party interaction in the method according to FIG. 1 in a schematic flow diagram,

FIG. 11 shows a further inventive method for creating a tokenized personal identification of a person or an organization in a decentralized computer network in a schematic flow diagram, and

FIG. 12 shows an inventive data processing system in a schematic flow diagram.

### DETAILED DESCRIPTION

The steps of the method performed at the decentralized network are denotes in the figures with a prefix, namely with “Cryptographic Passport” or short “CryptoPass”. E.g. the user is therefore denotes in the figures as CryptoPass user. In the following disclosure said prefix is mostly neglected to simplify the reading of the specification.

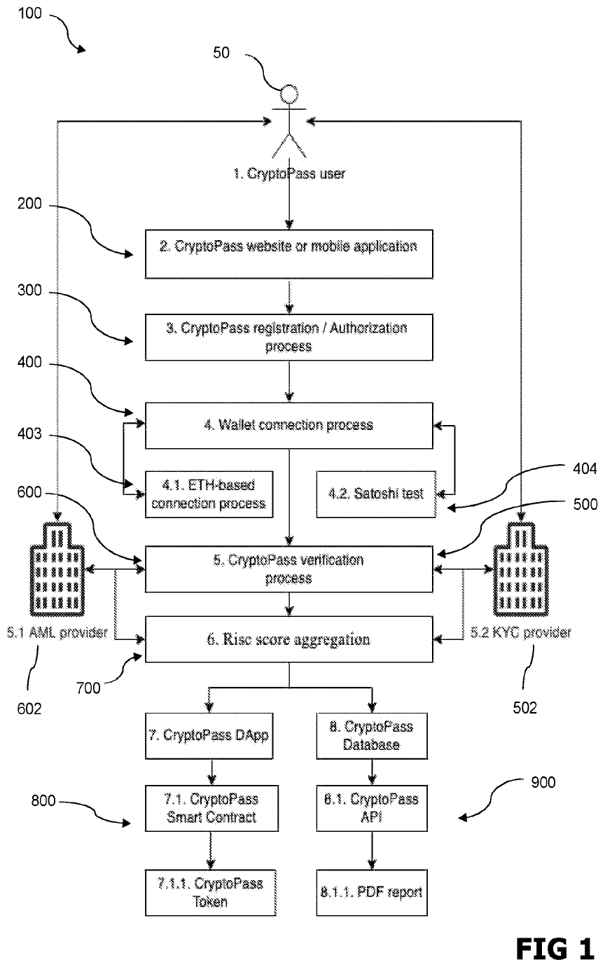

FIG. 1 to FIG. 9 show flow diagrams 100 to 1000 disclosing a first embodiment of a method for creating a tokenized personal identification of a person or an organization in a decentralized computer network. Said method comprises at least the following steps:
a) Providing a connection of a first computing device in a computer network ;
b) Receiving at least two verification requests regarding the person or organization via said first computing device in the computing network;
c) Providing of at least one risk management verification data, at least based on information delivered in the at least two verification requests in the computer network;
d) Creating at least one tokenized personal identification data in a decentralized computer network, while said tokenized personal identifications data consider at least the risk management verification data.

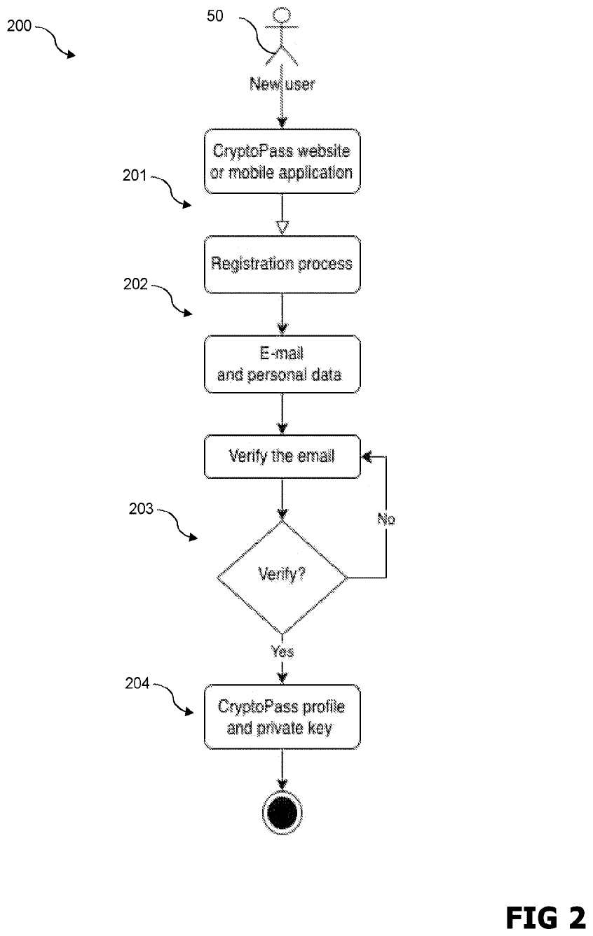

A new user 50 registers himself in a first step 200 on the CryptoPass website or via a mobile application to the decentralized network—see FIG. 2 for the details. The new user has to connect a first computing device in the computing network and will perform a registration process 201, using an e-mail address and personal data 202, e.g. name, surname, date of birth, nationality, etc. Said connection of the first computing device may occur using an internet connection, or a LAN connection, or a WLAN connection, wireless data connection, or mobile data connection, or using an ethernet cable, or satellite connection. Said e-mail address is verified 203 in the procedure and after a positive verification, said user may create a new profile 204 and will get a private key for entering to the decentralized network frequently. Said user may register himself just once and after registration the user becomes an existing user in the decentralized network.

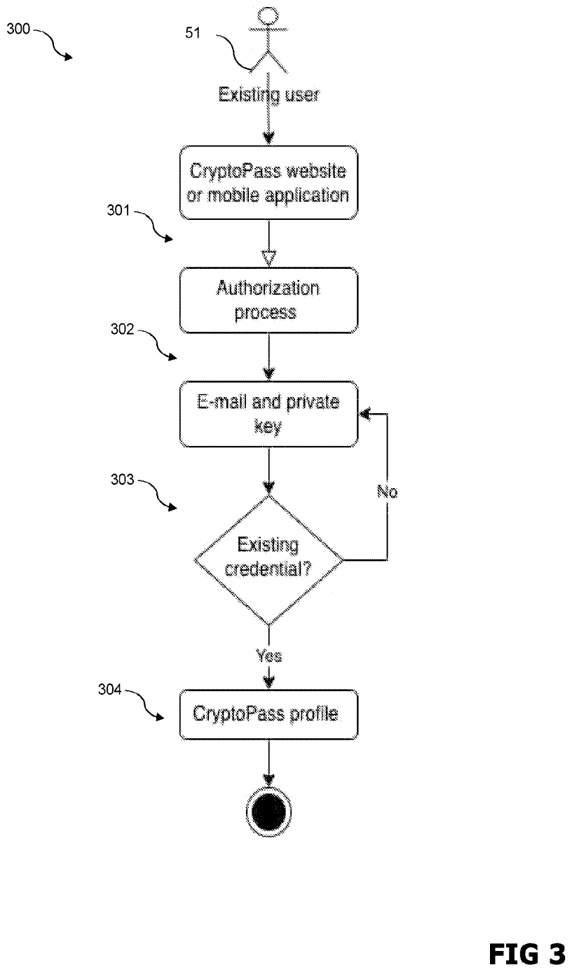

Said existing user 51 will proceed with an authorization procedure 300 performing an authorization process 301 on the website or the mobile application using said e-mail address and private key 302—see FIG. 3 for the details. If said credential verification 303 is positive, said CryptoPass user profile 304 is accepted and further steps in the inventive method are available.

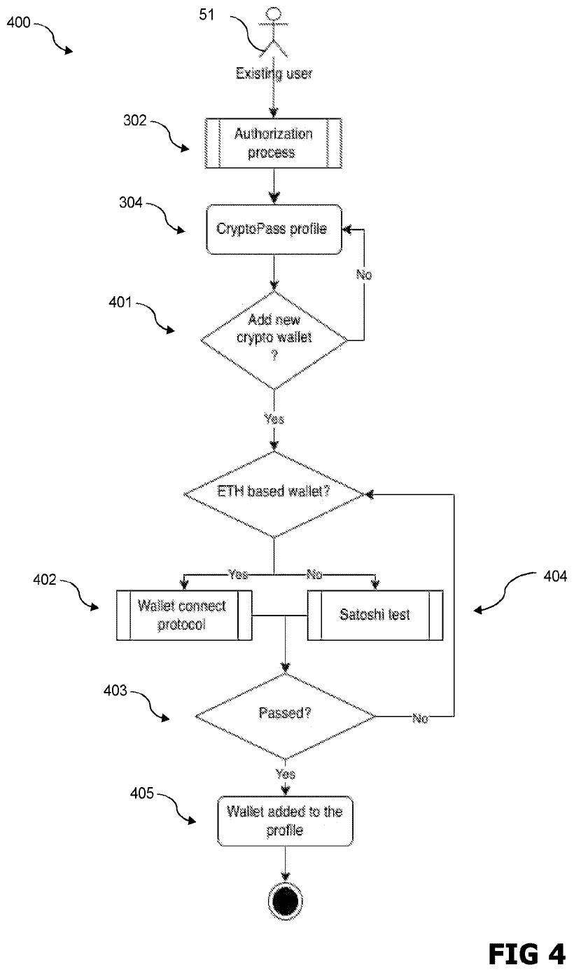

In a next step, said existing user will connect a cryptocurrency wallet to the computer network. Thus, an ownership verification process 400 is started to use said cryptocurrency wallet in the decentralized network—see FIG. 4 for the details. A first verification request 401 concerning said cryptocurrency wallet is performed in said method. Said cryptocurrency wallet is owned by the user of the first computing device, or said user has permission for using the cryptocurrency wallet. Said cryptocurrency wallet is used on the one hand to pay for services and on the other hand for verifying the ownership of the cryptocurrency wallet. Said ownership verification data process comprises a verification of the cryptocurrency wallet, using an ETH (Ethereum)-wallet check protocol 402, which ensure that the cryptocurrency wallet is an ETH-based wallet. In case of a positive verification, said cryptocurrency wallet is connected 403, otherwise a Satoshi test 404 is performed to verify said cryptocurrency wallet. While passing said ETH-wallet check, said cryptocurrency wallet is connected to the computer network, information data is provided, and said cryptocurrency wallet is advised to the user profile 405, for finalization of the proof of wallet ownership. Said information data involves at least one of cryptocurrency type, cryptocurrency wallet balance, a verification method, cryptocurrency wallet type.

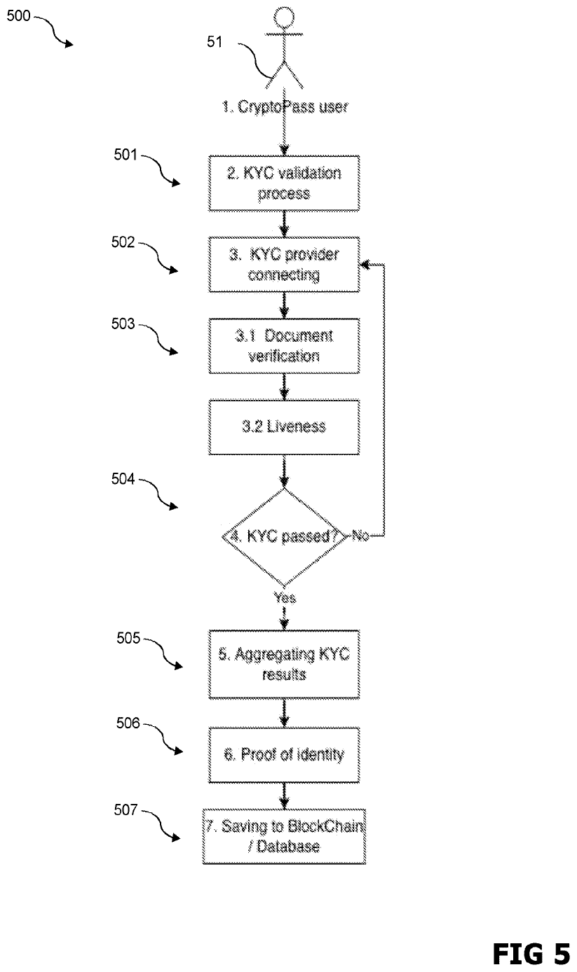

In a further verification request, a KYC (know your customer) procedure 500 is performed, comprising a KYC validation process 501—see FIG. 5 for the details. In the present disclosed embodiment, said KYC validation uses an external KYC provider 502, which is connected to the computing network. Said KYC verification requires KYC information of the user of the first computing device. Said required KYC information may comprise a document verification 503, including e.g. passport data or other official personal documents, like biometry data, or certificate of birth, or comparable authorized documents 504. If said KYC information data passes said verification 504, an aggregation of the verification data 505 is performed, and a proof of identity 506 of the user is provided. Said KYC verification data is saved in a blockchain in the decentralized network 507. A reliable KYC procedure of an external KYC provider comprises KYC information data involving name, surname, age, gender, jurisdiction, document type, biometry result, politically exposed person (PEP), KYC provider score, country of registration.

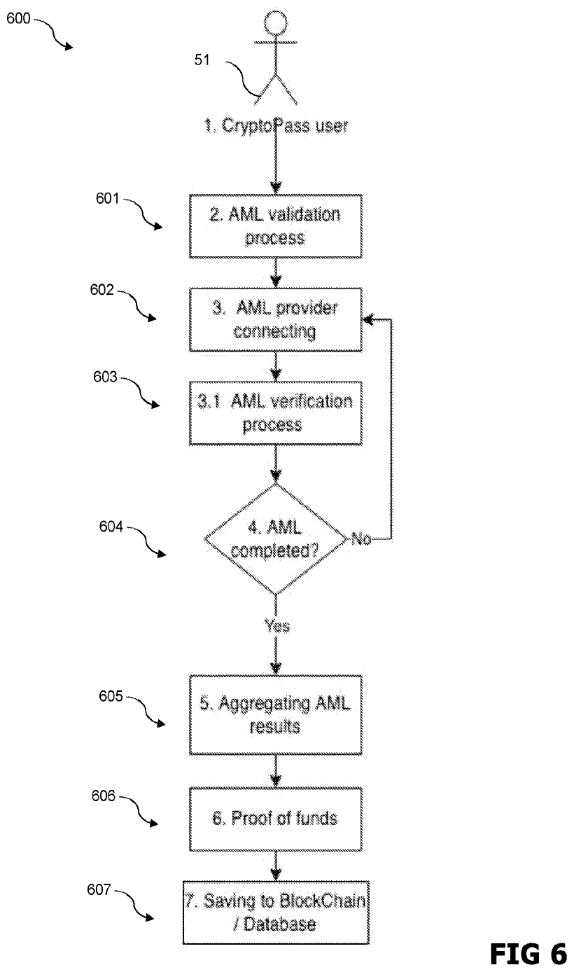

In a further verification request, an AML (anti-money laundering) procedure 600 is performed, comprising an ALM validation process 601—see FIG. 6 for the details. In the present disclosed embodiment said ALM validation uses an external ALM provider 602, which is connected to the computing network. Said ALM verification request 603 requires information of suspicious activity including the predicate offences to money laundering and terrorist financing, such as securities fraud and market manipulation of the user of the first computing device. If said ALM information data is complete 604, an aggregation of the verification data 605 is performed, and a proof of funds 606 of the user is provided. Said ALM verification data is saved in a blockchain in the decentralized network 607. A reliable ALM procedure of an external AML provider comprises an ALM provider risk score, a cryptocurrency wallet age, volumes and sizes of transactions, a cryptocurrency origin, a cryptocurrency wallet balance.

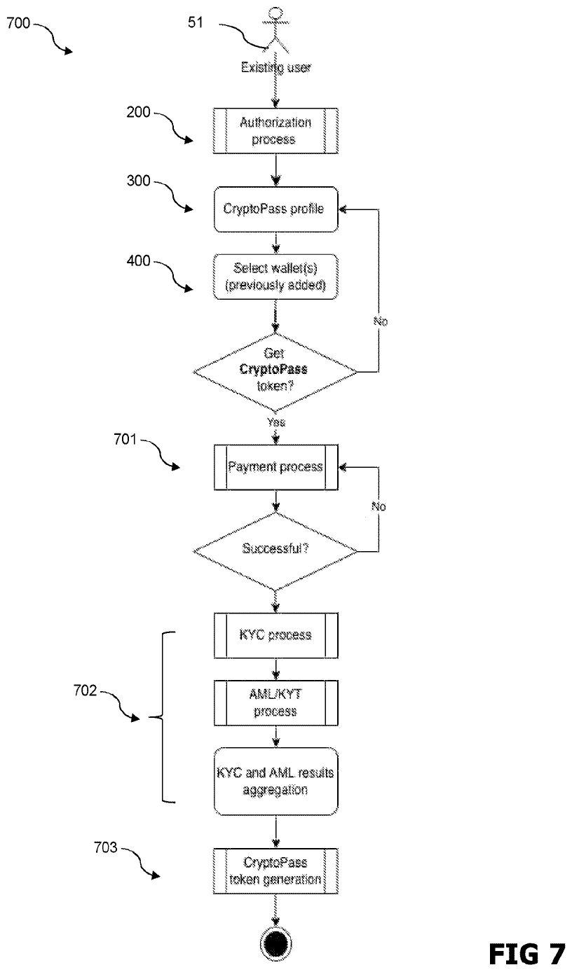

In step c) of the above-mentioned method, said risk management verification data 700 is provides, based on an aggregation 702 of the above-mentioned KYC information data, ALM information data and information data delivered by the ownership verification in the computer network. Said existing user must provide a payment 701 for accessing said risk management verification data and for the later emitted tokenized personal identification data—see FIG. 7 for the details. Said tokenized personal identification data is hosted on a public ETH-based blockchain platform as a tokenized personal identification data token. After payment 701 said aggregation 702 is performed and said tokenized personal identification data is created 703 in a decentralized computer network, while said tokenized personal identifications data consider the risk management verification data (step d)).

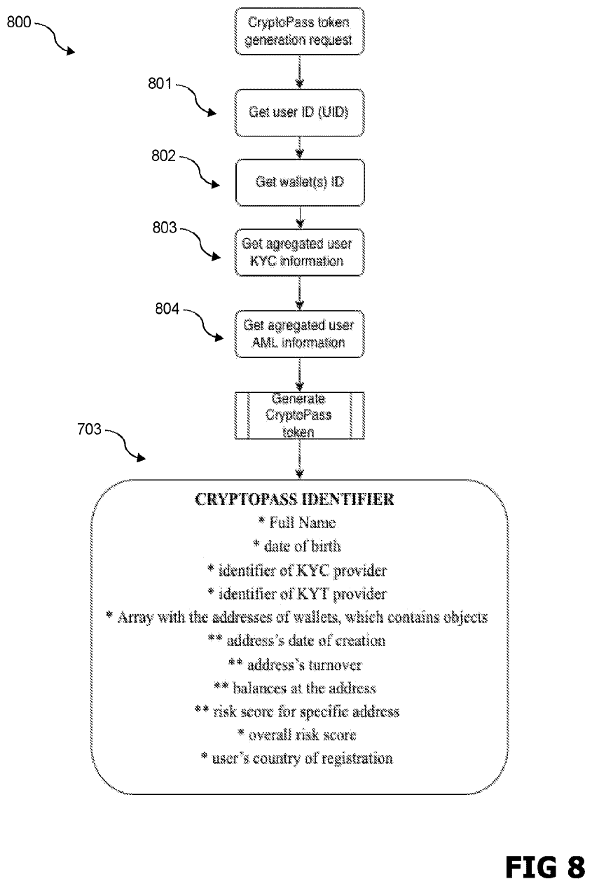

Said tokenized personal identification data comprises a demand of minima number of KYC information data, ALM information data and ownership information data of the user of the first computer device—see FIG. 8 for the details. This minima number 801 comprises e.g. a full name of the user, the date of birth (User ID) 801, an array of the address of the cryptocurrency wallet (wallet ID) 802, an identifier of the KYC (aggregated KYC information) 803, and the country of registration as well as said at least one risk management verification data. Said array of address of the cryptocurrency wallet may comprise an address's date of creation, an address's turnover, a balance at the address and/or a risk score for a specific address. In addition, said risk management verification data comprises an overall risk score composed of several risk scores and information data of KYC 803, of ALM 804 or ownership 802 verification data. Thus, an overall risk score may easily be used as a certificate of good standing for the business, the finance reputation as well as legal concerns. Said risk management verification data comprises at least one level of risk information. Thus, said information data of KYC, ALM or ownership may be categorized in several risk levels, which allows a better subdivision of the at least one risk management verification data. Some information data are weighted as very important and are weighted with a high multiplication, to adapt the risk score.

A database is connected to the computer network, comprising historical data. Said historical data comprises information data from KYC, ALM and/or ownership information, which is verified with the information data provided from the user of the environment and/or from the user of the first computing device or the KYC provide or the ALM provider. Said historical data is used to verify the at least one risk score and/or the risk management verification data. Historical user data or historical cryptocurrency wallet data is compared with the provided information data at least during said verification requests in step b). Said provided information data during the verification requests in step b) are saved as new historical data in said database.

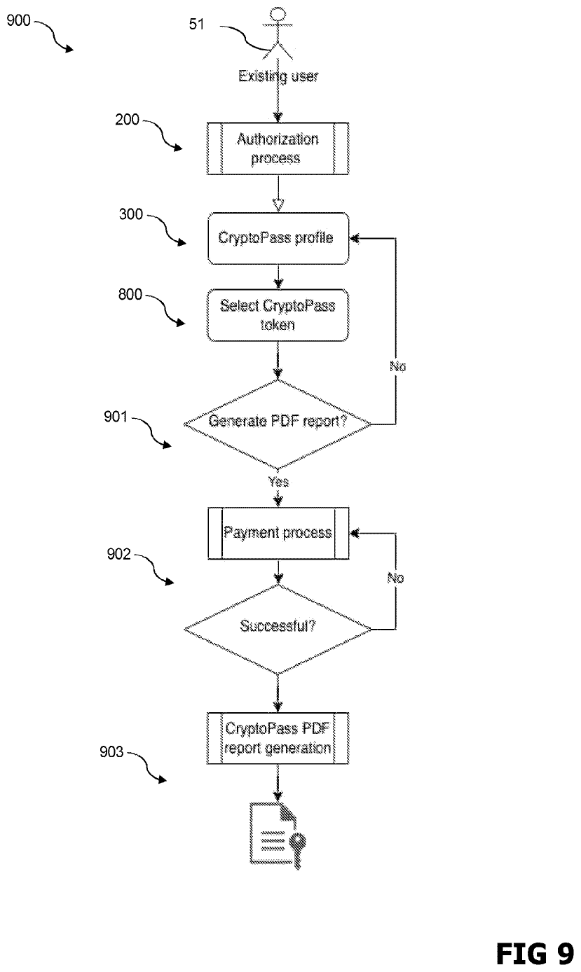

Said tokenized personal identification data is also used to create a certified document 900—see FIG. 9 for the details. The existing user gets the possibility to generate the certified document 903 after proceeding a report generation procedure 901. Said existing user must provide a payment 902 for generating of said certified document 903. The certified document 903 comprising the risk management verification data and/or the at least one risk score.

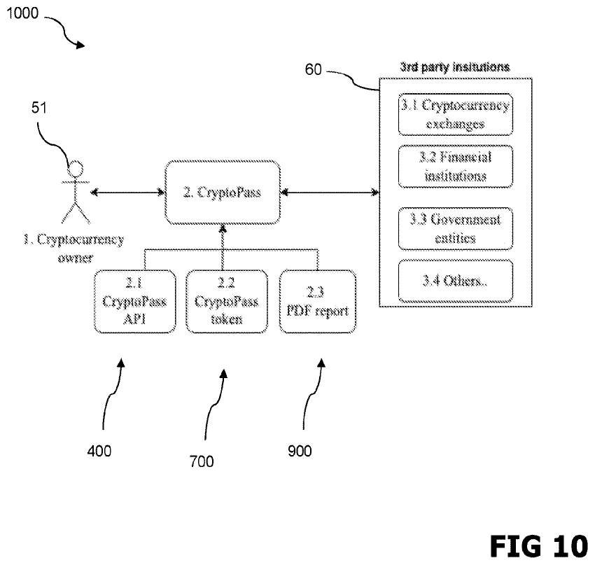

FIG. 10 shows a flow diagram 1000 disclosing the interaction of a third party 60 with the CryptoPass user, which already owns a tokenized personal identification data in form of a cryptographic token. Said tokenized personal identification data allows easy access to third party institutes and the exchange of data. Said third party institutions must provide a payment for access to the computer network and getting access to the tokenized personal identification data of the user.

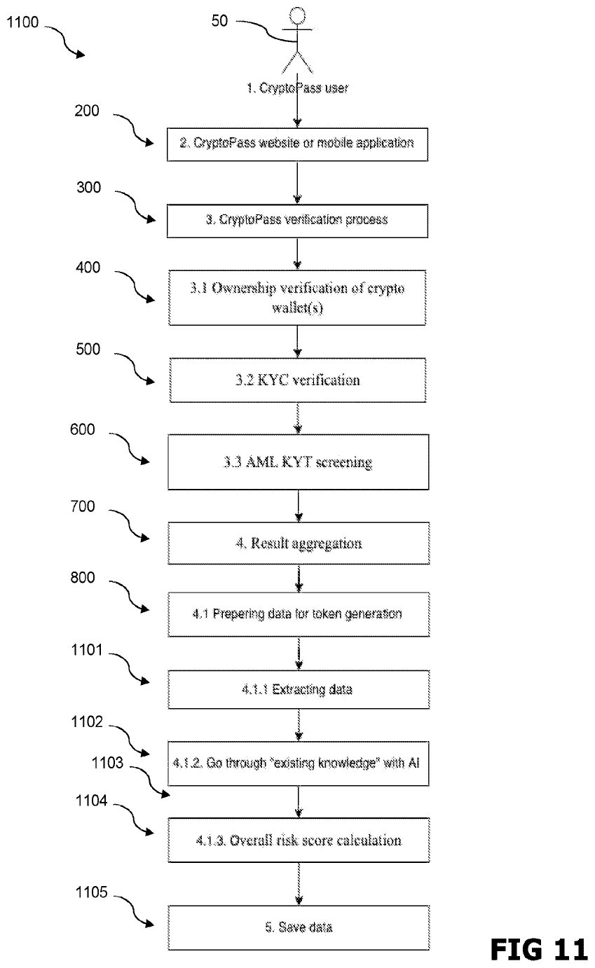

FIG. 11 shows a flow diagram 1100 disclosing a further embodiment of the method for creating a tokenized personal identification of a person or an organization in a decentralized computer network. Said further embodiment of the method comprises several steps of the embodiment concerning the FIG. 1 to FIG. 9. Said differences to the embodiment concerning the FIG. 1 to FIG. 9 are:

Said ownership verification data 400, said KYC verification data 500, and as well as said AML verification data 600 are provided by the existing user. Said risk management verification data is provided to an artificial intelligence (AI) module 1102, connected in the computing network. Said provided data is extracted 1101 and provided to the AI module 1102. Said AI module 1102 comprise at least one calculation algorithm like a neuronal network, a support vector machine or a transformer-calculation-unit for handling the above-mentioned extracted information data 1101, at least to provide said risk management verification data and/or to provide said risk score 1104. Said calculation algorithm of the AI is trained by historical information data and verification data of real user's verification requests 1103 and saved in a database 1105.

Said AI module 1103 may be used in another embodiment in the method according to the FIG. 1 to FIG. 9. Said AI module is used to aggregate said information data of KYC, ALM and/or ownership and to analyse said information data. Furthermore, said AI module may finally provide said risk score (not shown).

Furthermore, a computer program is configured to perform at least one method as herein disclosed.

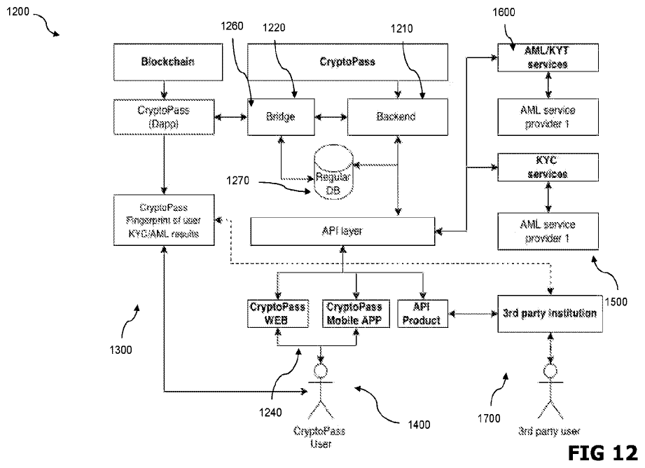

FIG. 12 shows a data processing system 1200 comprising means for carrying out the steps of any embodiment of the method as herein disclosed, comprising a decentralized network with several computers 1210, 1220 in a computer network, hosting at least one blockchain environment 1300, a CryptoPass environment 1400, KYC providers 1500, ALM providers 1600 and connection to a third-party institution 1700. Said data processing system 1200 works like a decentralized application (DApp) by verifying the user and provides a tokenized personal identification of a person or an organization.

Said data processing system 1200 offers a user of the first computing device 1240 an easy solution to provide the ownership and the origin of their assets. Said user connects a cryptocurrency wallet to said first computing device 1240.

A first Computer 1220 is a backend computer providing at least one AI module 1260. Said AI module 1260 will perform at least one of said above-mentioned methods. Said computer 1220 is connected to a database 1270. Said database 1270 is used to save information data about the users. Said database may consist of tables likes, users, name, surname, e-mail, date of birth, country, KYC provider, risk score, certified documents.

### REFERENCE LIST

50 new user
51 existing user
60 third party
100 first embodiment of a method
200-204 user registration steps
300-304 user authorisation steps
400-405 cryptocurrency wallet registration steps
500-507 KYC verification steps
600-607 AML verification steps
700-703 token generation steps
800-804 data aggregation for risk management data steps
900-903 certificated document generation steps
1000 third party interaction
1100-1105 alternative embodiment of said method
1200 data processing system
1210 computer
1220 computer
1240 first computing device
1260 AI module
1270 database
1300 blockchain environment
1400 CryptoPass environment
1500 KYC provider
1600 AML provider
1700 third-party institution

1. Method for creating a tokenized personal identification of a person or an organization in a decentralized computer network, while said method comprises the following steps:
a) Providing a connection of a first computing device in a computer network
b) Receiving at least two verification requests regarding the person or organization via said first computing device in the computing network
c) Providing of at least one risk management verification data, at least based on information delivered in the at least two verification requests in the computer network
d) Creating at least one tokenized personal identification data in a decentralized computer network, while said tokenized personal identifications data consider at least the risk management verification data.

2. The method according to claim 1, wherein said at least two verification requests comprise a KYC and/or an AML verification request.

3. (canceled)

4. The method according to claim 1, wherein before step b) at least one cryptocurrency wallet is connected to said computer network.

5. The method according to claim 4, wherein an ownership verification data process of the at least one cryptocurrency wallet is performed.

6. The method according to claim 1, wherein said at least one risk management verification data comprises a risk score, computed in a second computer device in the computer network.

7. The method according to claim 1, wherein said at least one risk management verification data comprises at least one level of risk information.

8. The method according to claim 1, wherein said decentralized computer network comprise at least one public blockchain and/or private blockchain.

9. The method according to claim 1, wherein a database is connected to the computer network, comprising historical data.

10. The method according to claim 1, wherein said at least one tokenized personal identification data is stored in a certified document.

11. The method according to claim 1, wherein a third-party institution is verified to the computer network and said at least one tokenized personal identification data and or said certified document is delivered to the third-party institution.

12. The method according to claim 1, wherein said risk management verification data is provided using an artificial intelligence (AI) module, connected in the computing network.

13. Computer program, configured to perform a method as claimed in claim 1.

14. Data processing system (1200) comprising means for carrying out the steps of the method according to claim 1.

15. The data processing system according to claim 14, wherein several computers (1210; 1220) are connected to form the decentralized computer network.

16. Data-The data processing system according to claim 1 , comprising at least one interface for connecting the first computing device (1240) to at least one computer (1210; 1220).

17. The data processing system according to claim 14, wherein at least one cryptocurrency wallet is connected to a computer (1210; 1220).

18. (canceled)

19. The data processing system according to claim 14, wherein at least one computer (1210; 1220) is a backend computer providing at least one AI module (1260).

20. The data processing system according to claim 14, wherein at least data server (1270) is connected to the decentralized computer network, providing historical data.

21. (canceled)

22. The method according to claim 5, wherein said at least one risk management verification data is further based on information data delivered by the ownership verification in the computer network.

23. The method according to claim 7, wherein said at least one risk management verification data comprises a multi-level of risk information.

24. The method according to claim 12, wherein said artificial intelligence module is based on a formula using the information of at least one information of the person or the organization, and/or at least one wallet information data and/or at least one information of the cryptocurrency.
